(19) United States
(12) Patent Application Publication
(10) Pub. No.: US 2023/0012630 A1
(43) Pub. Date: Jan. 19, 2023

(54) ELECTRIC RANGE PROVIDING SPECIFIC FUNCTIONS ACCORDING TO GESTURE OF USER

(71) Applicant: LG ELECTRONICS INC., Seoul (KR)

(72) Inventor: Howon SON, Seoul (KR)

(21) Appl. No.: 17/778,240

(22) PCT Filed: Sep. 10, 2020
(86) PCT No.: PCT/KR2020/012218

§ 371 Date: May 19, 2022

(30) Foreign Application Priority Data
Nov. 28, 2019 (KR) 10-2019-0155211

(51) Int. Cl. H05B 6/06; F24C 7/08; H05B 6/12

(52) U.S. Cl. CPC H05B 6/065; F24C 7/083; F24C 7/086; H05B 6/1209; H05B 2213/05

(57) ABSTRACT

Disclosed is an electric range which provides specific functions according to the gestures of a user. When an object to be heated that is currently being heated is moved to a different spot, the electric range determines in what way the object to be heated has been moved, and provides a specific function corresponding to the determined way of movement.

### TECHNICAL FIELD

The present disclosure relates to an electric range that provides specific functions according to a user's gesture.

### BACKGROUND ART

In homes or restaurants, various types of cooking utensils for heating food are used. The above-described cooking utensils include a gas stove using gas and an electric range using electricity.

The electric range is roughly divided into a resistance heating type electric range and an induction heating type electric range. The resistance heating type electric range generates heat by applying a current to a metal resistance line or a nonmetal heating element such as silicon carbide, and heats an item (e.g. a cooking vessel such as a pot or frying pan) by radiating or conducting the generated heat. The induction heating type electric range generates a magnetic field around a coil by applying high frequency power to the coil, and heats an item made of a metallic material, by using an eddy current generated from the generated magnetic field.

The heat power of the gas stove is adjusted through a knob operation, and the heat power of the electric range is controlled through a touch operation. However, compared to the knob operation, the touch operation cannot rapidly adjust heat power.

For example, when content of a cooking vessel boils over or is overheated, a user who uses the gas stove can rapidly lower heat power by rapidly rotating a knob, but a user who uses the electric range needs to repeatedly perform touch operations for adjusting heat power, and thus cannot rapidly lower the heat power.

Furthermore, the electric range provides various additional functions in addition to the heat power providing function. For example, the electric range provides a child lock function of an input interface and a timer function.

In the conventional electric range, however, a user needs to select an additional function by performing a separate operation in person.

### DISCLOSURE

### Technical Problem

An object of the present disclosure is to provide an electric range capable of rapidly adjusting heat power.

Also, a further object of the present disclosure is to provide an electric range capable of adjusting heat power or providing an additional function by using a user's gesture for a cooking vessel.

Also, a further object of the present disclosure is to provide an electric range capable of rapidly settling an emergency situation without a user's separate manipulation, even when the emergency situation occurs while cooking is performed.

Also, a further object of the present disclosure is to provide an electric range that conveniently provides an additional function different from a main function of providing heat power.

The objects of the present disclosure are not limited to the above-described objects, and other objects and advantages of the present disclosure, which are not mentioned, may be understood through the following descriptions, and more clearly understood by embodiments of the present disclosure. Furthermore, it may be easily known that the objects and advantages of the present disclosure can be implemented through means described in the claims and combinations thereof.

### Technical Solution

According to technique features of the present disclosure, an electric range determines how a heated item is moved, and provides a specific function corresponding to the determination result, when the heated item is moved to another position.

In an embodiment, an electric range may include: a case; a plurality of heating units arranged in the case, and disposed at a plurality of regions so as to be spaced apart from each other; a cover plate coupled to the top of the case; an input interface disposed on a top surface of the cover plate, and configured to display a specific image; and a control unit configured to control the heating units and the input interface. An item to be heated may be located at a first position on the top surface of the cover plate, and heated by the heating unit disposed at the first position. When the heated item is moved from the first position to a second position on the top surface of the cover plate, the control unit may determine how the heated item is moved, and controls at least one of the heating unit and the input interface to provide a function corresponding to the determination result.

In an embodiment, an electric range may include: a case; a plurality of heating units arranged in the case, and disposed at a plurality of regions so as to be spaced apart from each other; a cover plate coupled to the top of the case; an input interface disposed on a top surface of the cover plate, and configured to display a specific image; and a control unit configured to control the heating units and the input interface. An item to be heated may be located at a first position on the top surface of the cover plate, and heated by the heating unit disposed at the first position. When the heated item is lifted at the first position and moved to a second position on the top surface of the cover plate, the control unit may control the heating unit to provide a first heat power adjusting function, and when the heated item is slid from the first position to the second position, the control unit may control at least one of the heating unit and the input interface to provide a second heat power adjusting function or an additional function.

### Advantageous Effects

The electric range in accordance with the present disclosure may rapidly adjust heat power.

Furthermore, in accordance with the present disclosure, the electric range may adjust heat power or provide an additional function by using a user's gesture for a cooking vessel.

Furthermore, in accordance with the present disclosure, the electric range may rapidly settle an emergency situation without a user's separate manipulation, even when the emergency situation occurs while cooking is performed.

Furthermore, in accordance with the present disclosure, the electric range may conveniently provide an additional function different from a main function of providing heat power.

The above-described effects and specific effects of the present disclosure will be described while specific items for carrying out the present disclosure are described.

### BRIEF DESCRIPTION OF DRAWINGS

FIG. 1 is a perspective view illustrating a zone free-type induction heating device in accordance with an embodiment of the present disclosure.

FIG. 2 is a plan view illustrating the zone free-type induction heating device from which some components of FIG. 1 are omitted.

FIG. 3 is a schematic view for describing a control flow of the zone free-type induction heating device of FIG. 1.

FIG. 4 is a diagram illustrating a situation in which a heated item is moved on the top surface of the induction heating device in accordance with the embodiment of the present disclosure.

FIGS. 5A and 5B are diagrams illustrating the concept of methods in which a heated item is moved from a first position to a second position, in accordance with the embodiment of the present disclosure.

FIGS. 6 to 9 are diagrams for describing the concept of an operation of adjusting heat power by a working coil when a heated item is slid in a vertical direction, in accordance with the embodiment of the present disclosure.

FIGS. 10 to 13 are diagrams for describing the concept of an operation of the induction heating device to provide an additional function when a heated item is slid in a horizontal direction, in accordance with the embodiment of the present disclosure.

### DETAILED DESCRIPTION OF EXEMPLARY EMBODIMENT

The above-described objects, features and advantages will be described below in detail with reference to the accompanying drawings. Thus, the technical idea of the present disclosure can be easily carried out by those skilled in the art to which the present disclosure pertains. Moreover, in describing the present disclosure, detailed descriptions for publicly known arts related to the present disclosure will be ruled out in order not to unnecessarily obscure the subject matter of the present disclosure.

Hereafter, electric ranges in accordance with some embodiments of the present disclosure will be described. The same reference numerals in the drawings are used to represent like or similar components.

The electric range described in the present disclosure includes both a resistance heating type electric range and an induction heating type electric range, i.e. an induction heating device. In this case, for convenience of description, a zone free-type induction heating device will be taken as an example for describing the embodiments of the present disclosure. However, the present disclosure is not limited thereto. In particular, the present disclosure may be applied to other types of induction heating devices (e.g. flex type, half flex type, dual type and like) as well as a resistance heating type electric range and a zone free-type induction heating device.

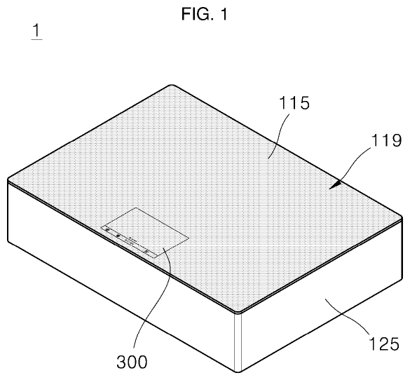

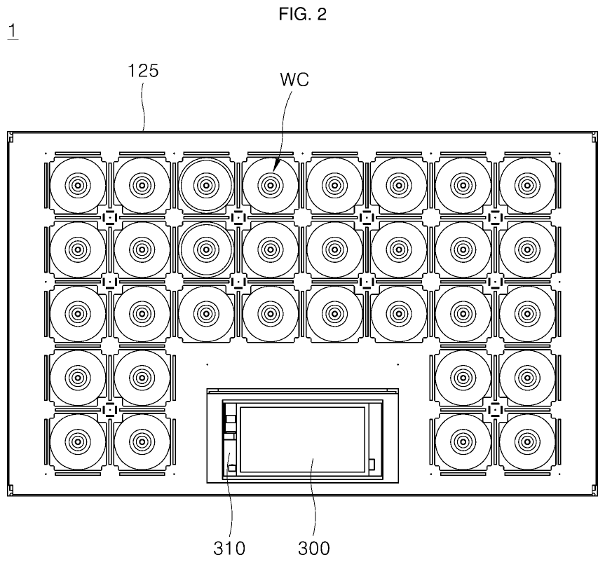

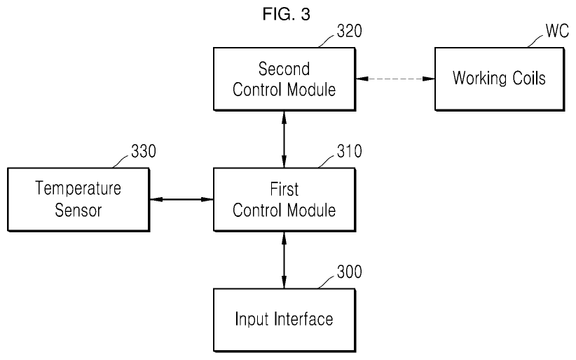

FIG. 1 is a perspective view illustrating a zone free-type induction heating device in accordance with an embodiment of the present disclosure. FIG. 2 is a plan view illustrating the zone free-type induction heating device from which some components of FIG. 1 are omitted. FIG. 3 is a schematic view for describing a control flow of the zone free-type induction heating device of FIG. 1.

For reference, FIG. 2 is a diagram from which a cover plate 119 of FIG. 1 is omitted, for convenience of description.

Referring to FIGS. 1 to 3, an induction heating device 1 in accordance with an embodiment of the present disclosure may include a case 125, the cover plate 119, an input interface 300, a first control module 310, a second control module 320, a temperature sensor 330, a plurality of working coils WC and the like.

For reference, although not illustrated in the drawings, various parts constituting the induction heating device 1 as well as the plurality of working coils WC may be installed in the case 125, the various parts including a base plate on which the working coils WC are installed, an indicator substrate support part on which an indicator substrate is installed, a plurality of light emitting elements installed on the indicator substrate, the indicator substrate configured to control the plurality of light emitting elements, a light guide configured to display light emitted from the light emitting elements through a light emitting surface, and a blowing fan for cooling heat generated by the working coils WC or the plurality of light emitting elements.

Furthermore, various devices related to the operations of the working coils WC may be installed in the case 125, but the detailed descriptions thereof will be omitted herein. The various devices include a power supply unit configured to provide AC power, a rectifier unit configured to rectify the AC power of the power supply unit into DC power, an inverter unit configured to convert the DC power rectified by the rectifier unit into a resonance current through a switching operation, and provide the resonance current to the working coils WC, the second control module 320 configured to control the inverter unit and parts related to the operation of the inverter unit, and a relay or semiconductor switch configured to turn on or off the working coils WC.

The case 125 may be insulated to prevent heat, generated by the working coils WC, from leaking to the outside.

The cover plate 119 may be coupled to the top of the case 125, and shield the inside of the case 125, and an item to be heated (not illustrated), i.e. an object to be heated by one or more of the plurality of working coils WC, may be disposed on the top surface of the cover plate 119.

Specifically, the cover plate 119 may include an upper plate 115 on which the item to be heated, such as a cooking vessel, is put, and heat generated by the working coils WC may be transferred to the item to be heated through the upper plate 115.

The upper plate 115 may be made of a glass material, for example, and the input interface 300 may be installed on the upper plate 115, the input interface 300 serving to receive an input from a user and transfer the corresponding input to the first control module 310. The first control module 310 is a control unit for controlling the input interface 300.

The input interface 300 may be flatly buried in the top surface of the cover plate 119, i.e. the upper plate 115, or flatly installed on the same plane as the upper plate 115, and serve to display a specific image. Furthermore, the input interface 300 may receive a touch input from a user, and provide the received touch input to the first control module 310.

Specifically, the input interface 300 may be a module through which a user inputs a desired heat power or heating time, and may be implemented as various parts such as physical buttons and a touch panel. Furthermore, the input interface 300 may also include a display panel configured to display the operation state of the induction heating device 1.

For reference, the input interface 300 may transfer an input received from the user to the first control module 310, and the first control module 310 may transfer the input to the second control module 320. This configuration will be described below in detail.

The temperature sensor 330 may sense the temperature of the cover plate 119.

Specifically, the temperature sensor 330 may sense the temperature of the cover plate 119, and provide the first control module 310 with information on the sensed temperature of the cover plate 119.

The first control module 310 may receive information on the temperature of the cover plate 119 from the temperature sensor 330, and determine whether to control the input interface 300 to display a remaining heat image, based on the received information on the temperature of the cover plate 119.

Specifically, the first control module 310 may control the operation of the input interface 300. That is, the input interface 300 may display a specific image according to a control command of the first control module 310.

Furthermore, the first control module 310 may receive a touch input of a user from the input interface 300, and transfer the received touch input to the second control module 320, or control or select a specific image displayed on the input interface 300 based on the received touch input.

The first control module 310 may receive information on the position of an item to be heated from the second control module 320, and control or select a specific image that is displayed on the input interface 300, based on the received information on the position of the item to be heated.

The second control module 320 may be a control unit for controlling the operations of the plurality of working coils WC, and may sense on which working coil WC of the plurality of working coils WC the item to be heated is located.

Specifically, the second control module 320 may control the inverter unit and the parts related to the operation of the inverter unit as described above, and thus control the operations of the plurality of working coils WC. Furthermore, the second control module 320 may provide the first control module 310 with the information on the sensed position of the item to be heated, and receive a user's touch input from the first control module 310.

The second control module 320 may control the operations of the plurality of working coils WC based on the user's touch input received from the first control module 310.

The plurality of working coils WC may be heating units for heating the item, and may be installed in the case 125.

Specifically, the operations of the plurality of working coils WC may be controlled by the second control module 320. That is, as illustrated in FIG. 2, the plurality of working coils WC may be arranged so as to be spaced by a predetermined distance apart from each other.

For convenience of description, however, one working coil WC will be taken as an example for description.

Specifically, the working coil WC may be implemented as a conducting wire which is wound a plurality of times in a ring shape, and serve to generate an AC magnetic field. Furthermore, under the working coil WC, a MICA sheet and a ferrite core may be sequentially arranged.

Furthermore, the ferrite core may be fixed to the MICA sheet through a sealant, and serve to diffuse the AC magnetic field generated by the working coil WC.

The MICA sheet may be fixed to the working coil WC and the ferrite core through a sealant, and prevent heat, generated by the working coil WC, from being directly transferred to the ferrite core.

The induction heating device 1 in accordance with the embodiment of the present disclosure may also have a wireless power transmission function based on the above-described configuration and features.

That is, a technology for wirelessly supplying power has been recently developed and applied to a lot of electronic devices. An electronic device to which the wireless power transmission technology is applied has a battery that is charged through an operation of simply putting the electronic device on a charging pad, even though the electronic device is not connected to a separate charging connector. Since the electronic device to which the wireless power transmission technology is applied requires no wired cord or charger, the portability thereof is improved, and the size and weight thereof are reduced further than in the related art.

Examples of the wireless power transmission technology include an electromagnetic induction method using a coil, a resonance method using resonance, and a wave radiation method that convert electrical energy into micro waves and transfers the micro waves. Among the wireless power transmission technologies, the electromagnetic induction method is a technology for transmitting power by using electromagnetic induction between a primary coil (e.g. working coil) installed on a device for wirelessly transmitting power and a secondary coil installed on a device for wirelessly receiving power.

The principle of the induction heating method of the induction heating device 1 is substantially the same as that of the wireless power transmission technology based on electromagnetic induction, in that an item to be heated is heated by electromagnetic induction.

Therefore, the induction heating device 1 in accordance with the embodiment of the present disclosure may have the wireless power transmission function as well as the induction heating function. Furthermore, since an induction heating mode or a wireless power transmission mode can be controlled by the first control module 310, the induction heating function or the wireless power transmission function may be selectively used, if necessary.

As such, the induction heating device 1 in accordance with the embodiment of the present disclosure has the above-described configuration and features. Hereafter, a heat power adjusting method of the induction heating device 1 will be described.

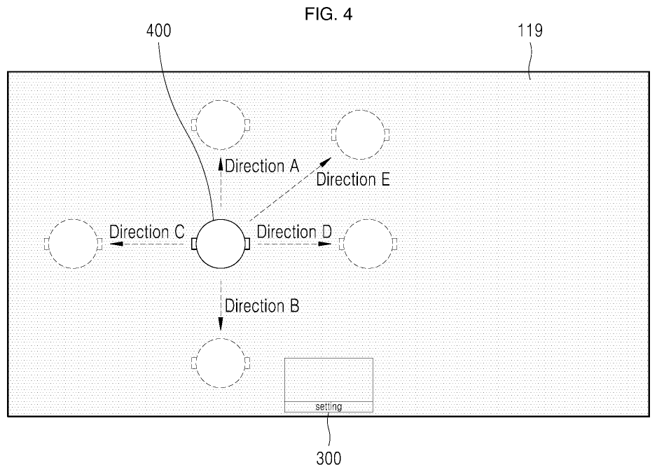

FIG. 4 is a diagram illustrating a situation in which an item to be heated is moved on the top surface of the induction heating device in accordance with the embodiment of the present disclosure.

In this case, the item to be heated (e.g. pot) is located at a first position on the top surface of the cover plate, and heated by at least one working coil disposed at the first position. Then, the heated item is moved to a second position on the top surface of the cover plate by a user's gesture (operation).

In this case, the second position is a position different from the first position, and may be a position located in any one direction of directions A, B, C, and D, or a position located in a direction E different from the directions A, B, C, and D.

The directions A and B are vertical directions, and the direction A (upward direction) is opposite to the direction B (downward direction). Furthermore, the directions C and D are horizontal directions, and the direction C (leftward direction) is opposite to the direction D (rightward direction). Furthermore, the direction E is a diagonal direction or another direction.

In accordance with an embodiment of the present disclosure, when an item to be heated was moved from the first position to the second position on the top surface of the cover plate, the control unit may determine how the item to be heated was moved, and control at least one of the working coil and the input interface to provide a specific function corresponding to the determination result.

In this case, the control unit includes a first control module and a second control module.

The specific function includes a first heat power adjusting function, a second heat power adjusting function, and an additional function.

The first heat power adjusting function may be a function of setting heat power by at least one working coil disposed at the second position to the same heat power as heat power by at least one working coil disposed at the first position.

The second heat power adjusting function may be a function of setting heat power by at least one working coil disposed at the second position to heat power different from heat power by at least one working coil disposed at the first position. Therefore, through the second heat power adjusting function, the heat power by at least one working coil disposed at the second position may become larger or smaller than the heat power by at least one working coil disposed at the first position.

The additional function may be different from a main function of providing heat power through the working coil. For example, the additional function may include a child lock function, a timer function and the like. However, the present disclosure is not limited thereto, and various additional functions may be provided to the user through an operation which will be described below.

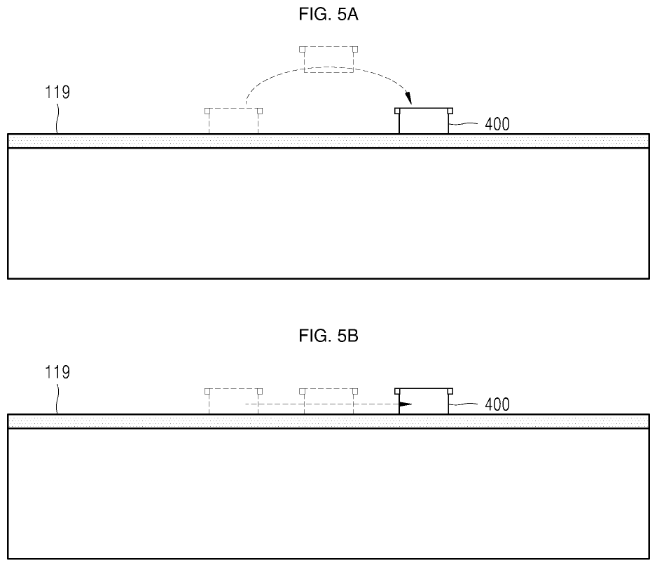

FIGS. 5A and 5B illustrate the concepts of methods in which the item to be heated is moved from the first position to the second position.

Referring to FIG. 5A, the item to be heated may be lifted at the first position and moved to the second position. Referring to FIG. 5B, the item to be heated may be slid from the first position to the second position.

In accordance with the embodiment of the present disclosure, when the item to be heated is lifted at the first position and moved to the second position, the control unit may control at least one working coil, disposed at the second position, to provide the first heat power adjusting function.

In this case, the second position may be a position located in any one direction of the directions A, B, C, D, and E. That is, the second position may be a position located in the vertical direction (the direction A or B), a position located in the horizontal direction (the direction C or D), or a position located in a random direction (the direction E) different from the vertical and horizontal directions.

In accordance with the embodiment of the present disclosure, when the item to be heated is slid from the first position to the second position, the second control module may control at least one of the input interface and at least one working coil to provide the second heat power adjusting function or an additional function.

In this case, in accordance with an embodiment of the present disclosure, when the item to be heated is slid in the first direction of the vertical and horizontal directions and located at the second position, the control unit controls at least one working coil, disposed at the second position, to provide the second heat power adjusting function. Furthermore, in accordance with an embodiment of the present disclosure, when the item to be heated is slid in the second direction of the vertical and horizontal directions and located at the second position, the control unit controls at least one of the input interface and at least one working coil disposed at the second position in order to provide an additional function.

In this case, the first direction may be any one direction of the vertical and horizontal directions, and the second direction may be the other direction of the vertical and horizontal directions, which is different from the first direction. For example, when the first direction is the vertical direction, the second direction may be the horizontal direction, and when the first direction is the horizontal direction, the second direction may be the vertical direction.

For convenience of description, the first direction is defined as the vertical direction, the second direction is defined as the horizontal direction, the direction A is defined as the upward direction, the direction B is defined as the downward direction, the direction C is defined as the leftward direction, and the direction D is defined as the rightward direction. However, the preset disclosure is not limited thereto.

The second control module may measure how much a resonance current flowing through the working coil is attenuated or measure the height of the item to be heated, and thus determine how the item to be heated was moved. In this case, in order to measure the height of the item to be heated, a height measurement unit (not illustrated) may be disposed on the top surface of the cover plate of the induction heating device.

Hereafter, the operation of the induction heating device will be described in more detail with reference to the following drawings.

1. Situation in which heated item is lifted and moved from first position to second position

Referring to FIG. 5A, when the item heated at the first position is lifted and moved to the second position, the second control module may control the heat power by at least one working coil located at the second position in order to provide the first heat power adjusting function.

The second position may be a position on the top surface of the cover plate, which is located in the vertical direction, a position on the top surface of the cover plate, which is located in the horizontal direction, or a position located in a different direction except the vertical and horizontal directions.

That is, when the heated item is lifted at the first position and moved to the second position, the second control module may control at least one working coil disposed at the second position, such that the heat power of the second position is set to the same heat power as that of the first position.

In this case, the second control module may determine whether the heated item was lifted, based on the attenuation of a resonance current flowing through the working coil and/or the height of the item.

More specifically, the resonance current may be generated in at least one working coil disposed at the first position and at least one working coil disposed at the second coil, and no resonance current may be generated in at least one working coil disposed between the first position and the second position.

In this case, the second control module may determine that the heated item is not located at one or more positions between the first position and the second position. Therefore, the second control module may determine that the heated item is being lifted and moved from the first position to the second position.

Furthermore, the height measurement unit (not illustrated) may measure the height of the heated item. In this case, the height of the heated item located at the first position and the height of the heated item located at the second position may be measured as “0”, and the height of the heated item located at one or more positions between the first position and the second position may be measured as a value equal to or more than “0”.

In this case, the second control module may determine that the heated item is not located at one or more positions between the first position and the second position. Therefore, when the measured height of the heated item is equal to or more than a critical height, the second control module may determine that the heated item is lifted at the first position and moved to the second position. The critical height may be set to a very small height close to “0” in consideration of an error.

In short, the user may perform cooking by using two or more cooking vessels (items to be heated). In this case, the user may perform cooking by using a first cooking vessel at the first position of the cover plate, and move the first cooking vessel to the second position different from the first position, and then perform cooking by using a second cooking vessel at the first position.

In this case, the user may make a gesture of lifting the first cooking vessel and moving the first cooling vessel from the first position to the second position, and the induction heating device provides the same heat power as the first position to the second position. Therefore, the heat power of the induction heating device 1 may be rapidly and conveniently adjusted without user intervention.

2. Situation in which heated item is vertically slid on top surface of cover plate

Referring to FIG. 5B, when the item heated at the first position is slid to the second position located in the vertical direction, the control unit may control the heat power by at least one working coil located at the second position in order to provide the second heat power adjusting function.

That is, when the heated item is slid from the first position to the second position in the vertical direction, the second control module may control at least one working coil disposed at the second position, such that the heat power of the second position is set to heat power different from that of the first position.

More specifically, when the item heated at the first position is slid in any one direction (i.e. first-first direction) of the upward direction and the downward direction, the second control module may increase or maintain heat power by at least one working coil disposed in the first-first direction based on the first position.

Furthermore, when the item heated at the first position is slid in the other direction (i.e. first-second direction) of the upward direction and the downward direction, the second control module may decrease or maintain heat power by at least one working coil disposed in the first-second direction based on the first position.

In this case, first heat power by at least one working coil at the first position and the distance by which the heated item is slid from the first position may be used to set the heat power by the working coil.

For convenience of description, it is assumed that the first-first direction is the upward direction, and the first-second direction is the downward direction. However, the preset disclosure is not limited thereto.

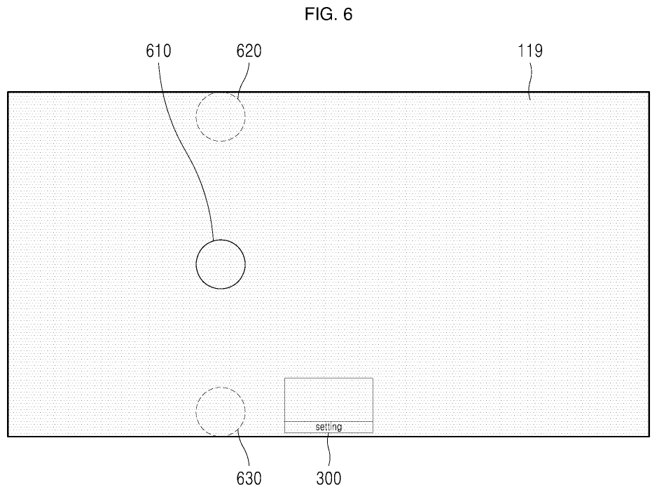

FIGS. 6 to 9 are diagrams for describing the concept of an operation of adjusting heat power by the working coil when an item to be heated is slid in the vertical direction, in accordance with the embodiment of the present disclosure.

Referring to FIG. 6, an end position 620 in the upward direction indicates a position that has the same horizontal-axis coordinate as a first position 610, and abuts on the upper edge of the top surface of the cover plate. Furthermore, an end position 630 in the downward direction indicates a position that has the same horizontal-axis coordinate as the first position 610, and abuts on the lower edge of the top surface of the cover plate.

The detailed contents of the configuration for setting heat power by the working coil will be described as follows.

In accordance with the embodiment of the present disclosure, when the first heat power of the first position 610 is smaller than default maximum heat power by the working coil, the second control module may set, to the default maximum heat power, heat power by at least one working coil disposed at the end position 620 in the upward direction, and sequentially increase the heat power by at least one working coil, disposed between the first position 610 and the end position 620 in the upward direction, in proportion to a sliding distance.

In this case, the heat power by at least one working coil disposed between the first position 610 and the end position 620 in the upward direction is larger than the first heat power and smaller than the default maximum heat power. The default maximum heat power is a preset value.

In accordance with the embodiment of the present disclosure, when the first heat power of the first position 610 is larger than default minimum heat power by the working coil, the second control module may set, to the default minimum heat power, heat power by at least one working coil disposed at the end position 630 in the downward direction, and sequentially decrease the heat power by at least one working coil, disposed between the first position 610 and the end position 630 in the downward direction, in proportion to a sliding distance.

In this case, the heat power by at least one working coil disposed between the first position 610 and the end position 630 in the downward direction is smaller than the default minimum heat power and larger than the first heat power. The default minimum heat power is a preset value.

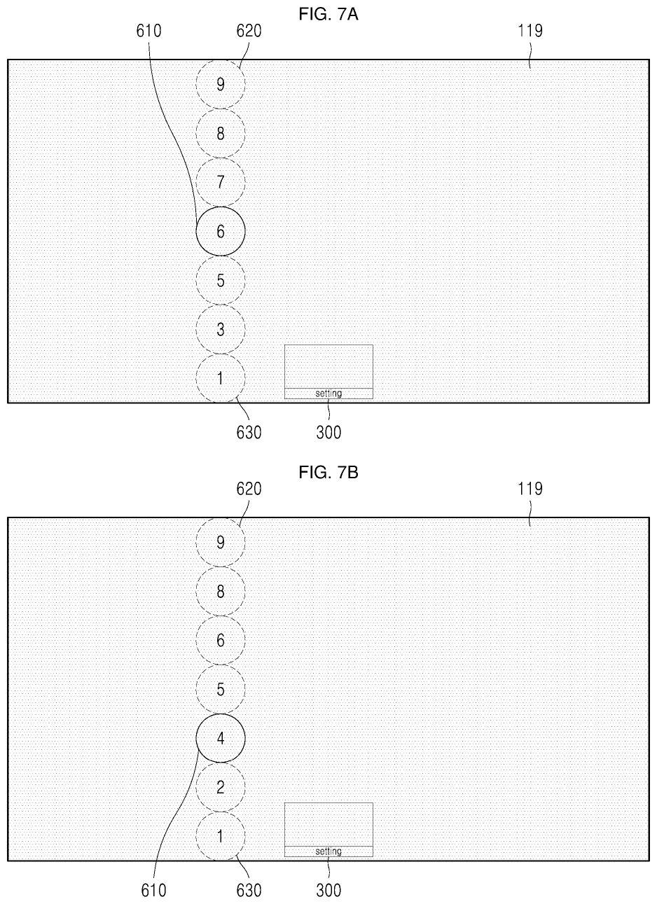

For example, FIG. 7A is based on the assumption that the first heat power of the first position 610 at which the item to be heated is disposed is “6”, the default maximum heat power is set to “9”, and the default minimum heat power is set to “1”.

In this case, the second control module sets, to the default maximum heat power of “9”, the heat power by at least one working coil disposed at the end position 620 in the upward direction. Furthermore, the second control module sequentially increases the heat power by at least one working coil, disposed between the first position 610 and the end position 620 in the upward direction, in proportion to the sliding distance. For example, the second control module increases the heat power from “7” to “8”.

Furthermore, the second control module sets, to the default minimum heat power of “1”, the heat power by at least one working coil disposed at the end position 630 in the downward direction. Furthermore, the second control module sequentially decreases the heat power by at least one working coil, disposed between the first position 610 and the end position 630 in the downward direction, in proportion to the sliding distance. For example, the second control module decreases the heat power from “5” to “3”.

For another example, FIG. 7B is based on the assumption that the first heat power of the first position 610 at which the item to be heated is disposed is “4”, the default maximum heat power is set to “9”, and the default minimum heat power is set to “1”.

In this case, the second control module sets, to the default maximum heat power of “9”, the heat power by at least one working coil disposed at the end position 620 in the upward direction. Furthermore, the second control module sequentially increases the heat power by at least one working coil, disposed between the first position 610 and the end position 620 in the upward direction, in proportion to the sliding distance. For example, the second control module increases the heat power from “5” to “6”, and “6” to “8”.

Furthermore, the second control module sets, to the default minimum heat power of “1”, the heat power by at least one working coil disposed at the end position 630 in the downward direction. Furthermore, the second control module sequentially decreases the heat power by at least one working coil, disposed between the first position 610 and the end position 630 in the downward direction, in proportion to the sliding distance. For example, the second control module decreases the heat power to “2”.

In some cases, the first heat power of the first position 610 at which the item to be heated is disposed may be equal to the default maximum heat power. In this case, the second control module may set, to the default maximum heat power, the heat power by at least one working coil disposed in the upward direction from the first position 610. Even in this case, the second control module may sequentially decrease the heat power by at least one working coil, disposed in the downward direction from the first position 610, in proportion to a sliding distance.

Furthermore, in some cases, the first heat power of the first position 610 at which the item to be heated is disposed may be equal to the default minimum heat power. In this case, the second control module may set, to the default minimum heat power, heat power by at least one working coil disposed in the downward direction from the first position 610. Even in this case, the second control module may sequentially increase the heat power by at least one working coil, disposed in the upward direction from the first position 610, in proportion to a sliding distance.

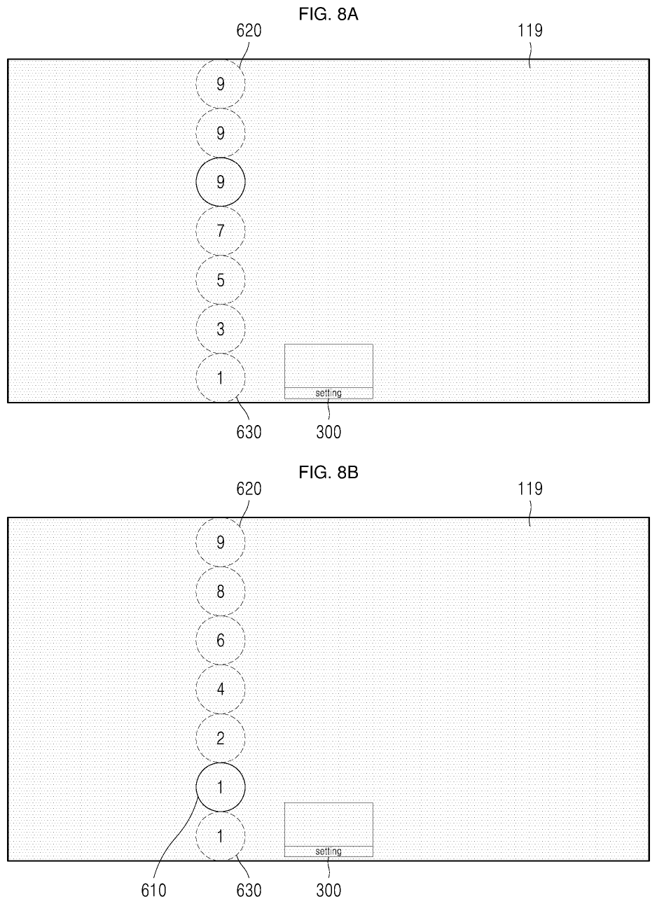

For example, FIG. 8A is based on the assumption that the first heat power of the first position 610 at which the item to be heated is disposed is “9”, the default maximum heat power is set to “9”, and the default minimum heat power is set to “1”.

In this case, the second control module may set, to the default maximum heat power of “9”, the heat power by at least one working coil disposed in the upward direction from the first position 610. Furthermore, the second control module sets, to the default minimum heat power of “1”, the heat power by at least one working coil disposed at the end position 630 in the downward direction, and sequentially decreases the heat power by at least one working coil, disposed between the first position 610 and the end position 630 in the downward direction, in proportion to the sliding distance.

For another example, FIG. 8B is based on the assumption that the first heat power of the first position 610 at which the item to be heated is disposed is “1”, the default maximum heat power is set to “9”, and the default minimum heat power is set to “1”.

In this case, the second control module sets, to the default minimum heat power of “1”, the heat power by at least one working coil disposed in the downward direction from the first position 610. Furthermore, the second control module sets, to the default maximum heat power of “9”, the heat power by at least one working coil disposed at the end position 630 in the upward direction, and sequentially increases the heat power by at least one working coil, disposed between the first position 610 and the end position 630 in the upward direction, in proportion to the sliding distance.

In some cases, the first position 610 at which the item to be heated is disposed may be the end position 620 in the upward direction, the heat power of the first position 610 at which the item to be heated is disposed may be the default minimum heat power, and the item to be heated may be slid in the downward direction.

In this case, the second control module may change the heat power adjustment setting. In the above-described situation, the second control module may change the setting to increase the heat power of the heating unit, disposed in the downward direction from the first position 610, in proportion to a sliding distance. This process is illustrated in FIG. 8A.

Furthermore, in some cases, the first position 610 at which the item to be heated is disposed may be the end position 630 in the downward direction, the heat power of the first position 610 at which the item to be heated is disposed may be the default maximum heat power, and the item to be heated may be slid in the upward direction.

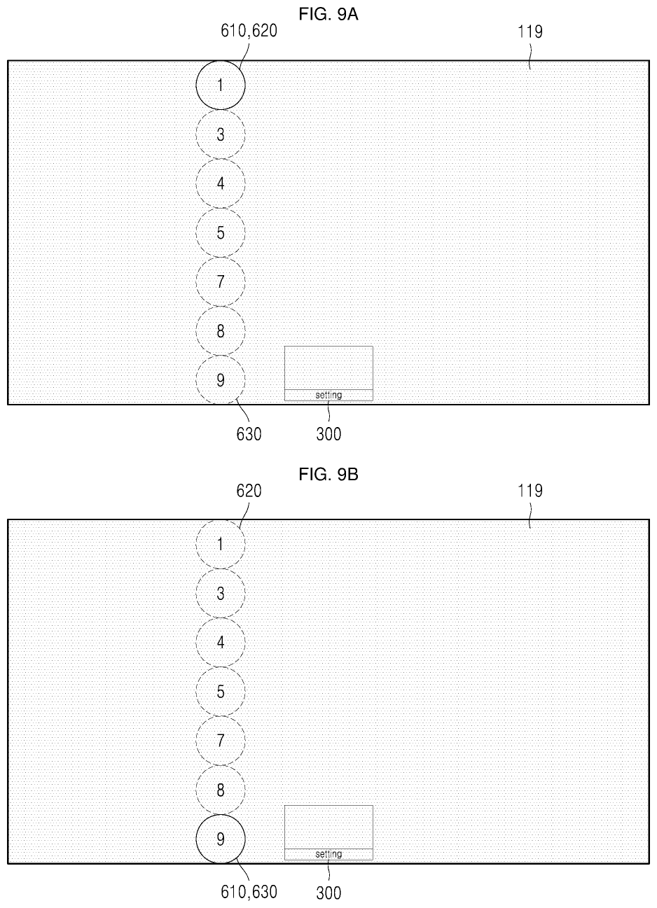

In this case, the second control module may change the heat power adjustment setting. In the above-described situation, the second control module may change the setting to decrease the heat power of the heating unit, disposed in the upward direction from the first position 610, in proportion to a sliding distance. This process is illustrated in FIG. 9B.

When the heat power is changed by the sliding, the heat power change may be displayed on the input interface.

In accordance with another embodiment of the present disclosure, when the item heated at the first position is moved in the upward or downward direction, the second control module may set the heat power by at least one working coil, disposed in the direction that the heated item is slid from the first position, to lower heat power than the heat power by at least one working coil disposed at the first position. That is, in accordance with the present disclosure, when the heated item is vertically moved regardless of the upward direction and the downward direction, the second control module may set the heat power of the second position to lower heat power than the heat power of the first position based on the sliding distance.

In short, the item to be heated may be heated by the working coil at the first position of the cover plate. When the heating lasts for a long time, an emergency situation in which content (e.g. soup) contained in the heated item boils over may occur. Therefore, a user may perform an operation of reducing the heat power at the first position or lifting the heated item from the cover plate and cooling the heated item.

In this case, when the user uses both hands to move the heated item, the user does not adjust the heat power of the working coil, and needs to move the heated item to another position and then adjust the heat power of the working coil. Therefore, the user experiences inconvenience when adjusting the heat power.

Alternatively, when the user uses one hand to grasp the heated item and adjusts the heat power of the working coil with the other hand, the user may not rapidly adjust the heat power due to the inconvenience of a touch operation, even though the user can adjust the heat power.

Therefore, the present disclosure aims at rapidly and conveniently adjusting the heat power of the induction heating device without user intervention, when an emergency situation occurs. Thus, when the user makes a gesture to slide the heated item in the vertical direction, the induction heating device in accordance with the embodiment of the present disclosure may decrease the heat power of the working coil based on the sliding distance.

In accordance with another embodiment of the present disclosure, when the heated item is slid in the vertical direction on the top surface of the cover plate, the first control module may generate a guidance message for adjusting the heat power by at least one working coil disposed in the vertical direction, while the heat power by at least one working coil disposed in the vertical direction is not automatically adjusted.

In this case, the induction heating device may include a speaker (not illustrated) and a microphone (not illustrated) which are disposed on the top surface of the cover plate, and the generated guidance message may be outputted as a voice signal, or displayed as a specific image on the input interface.

For example, when the heated item is slid in the vertical direction and the first heat power is “3”, the first control module may generate a guidance message saying “Would you set the heat power to 6?”, based on the first heat power at the first position and the sliding distance. The guidance message is outputted to the speaker (not illustrated) or the input interface. In this case, the user may input a voice command signal or touch the input interface to respond to the guidance message.

For another example, when the heated item is slid in the vertical direction, the first control module may generate a guidance message saying “Which level do you set the heat power to?”. The guidance message is outputted to the speaker (not illustrated) or the input interface. In this case, the user may say a voice command signal or touch the input interface to respond to the guidance message.

3. Situation in which heated item is slid in horizontal direction on top surface of cover plate

Referring to FIG. 5B, when the item heated at the first position is slid to the second position located in the horizontal direction, the control unit may control at least one of the input interface and at least one working coil located at the second position in order to provide an additional function.

Examples of the additional function may include a child lock function, a timer function and the like. However, the present disclosure is not limited thereto. In order to provide the additional function, the distance by which the heated item is slid from the first position may be used.

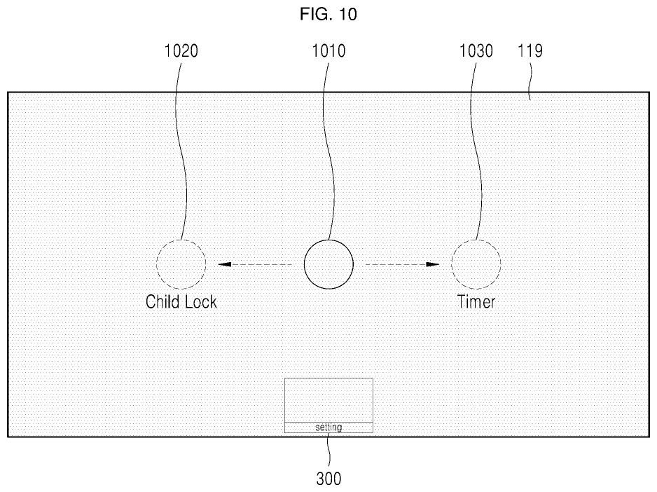

FIGS. 10 to 13 are diagrams for describing the concept of an operation of the induction heating device to provide an additional function when the heated item is slid in the horizontal direction, in accordance with the embodiment of the present disclosure.

Referring to FIG. 10, when the heated item is slid to a second-first position 1020 spaced by a first distance apart from a first position 1010 in the horizontal direction, the control unit may provide a first additional function.

For example, the second-first position 1020 may be spaced by the first distance apart from the first position 1010 to the left. The first additional function may be the child lock function.

The child lock function indicates a function of setting the input interface to a lock state while the heat power at the second-first position 1020 is fixed to the first heat power. The lock state indicates that physical buttons or virtual buttons displayed on the input interface are not manipulated even when a user's touch is inputted.

That is, when the user slides the heated item, located at the first position 1010, to the second-first position 1020 spaced by the first distance apart from the first position 1010 to the left, the second control module may set the heat power of the second-first position 1020 to the same heat power as the first heat power of the first position 1010, and the first control module may set the input interface to a lock state.

FIG. 10 illustrates that the first additional function is provided when the heated item is slid by the first distance to the left, but the present disclosure is not limited thereto. That is, when the heated item is slid by the first distance to the right, the first additional function may be provided. In this case, the second-first position 1020 may not overlap a second-second position 1030 which is present in the rightward direction and will be described below.

Referring to FIG. 10, when the heated item is slid to the second-second position 1030 spaced by a second distance apart from the first position 1010 in the horizontal direction, the control unit may provide a second additional function.

For example, the second-second position 1030 may be spaced by the second distance apart from the first position 1010 to the right. The second additional function may be a timer function.

The timer function may indicate a function of maintaining the first heat power for a specific time while the heat power of the second-second position 1030 is fixed to the first heat power, and then turning off the heat power of the second-second position 1030.

That is, when the user slides the heated item, located at the first position 1010, to the second-second position 1030 that is spaced by the second distance apart from the first position 1010 to the right, the second control module may set the heat power of the second-second position 1030 to the same heat power as the first heat power of the first position 1010, and maintain the heat power of the second-second position 1030 for the specific time and then turn off the heat power of the second-second position 1030 after the specific time has elapsed. In this case, the first control module may display, on the input interface, the specific time and the real time the real time after the specific time has elapsed.

FIG. 10 illustrates that the second additional function is provided when the heated item is slid by the second distance to the right, but the present disclosure is not limited thereto. That is, when the heated item is slid by the second distance to the left, the second additional function may be provided. In this case, the second-second position 1030 may not overlap the second-first position 1020.

In accordance with the embodiment of the present disclosure, the control unit may set the time of the timer in proportion to the distance by which the heated item is slid in the second direction. That is, when the heated item is slid by a long distance, the setting time of the timer may have a large time value, and when the heated item is slid by a short distance, the setting time of the timer may have a small time value.

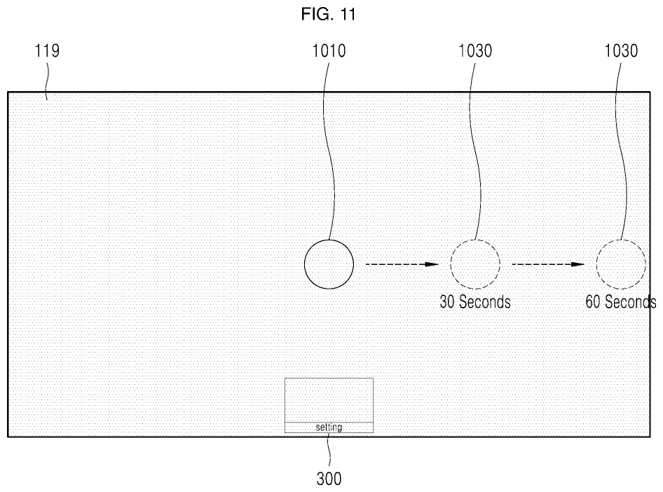

FIG. 11 illustrates an example in which the timer function is set in accordance with the embodiment of the present disclosure.

Referring to FIG. 11, when the heated item is moved by 0.1 m, the time of the timer may be set to 30 seconds, and when the heated item is moved by 0.2 m, the time of the timer may be set to 60 seconds.

When the time of the timer is set by the sliding, the user may request a longer time for the timer in some cases. In the example of FIG. 11, the user may request 120 seconds for the timer.

In order to solve such a situation, when the heated item is slid and located at an end position in the rightward direction, i.e. the second-second position 1030, and then relocated at the second-second position 1030 within a preset time (very short time), the control unit controls the input interface to display a first image for setting the time of the timer.

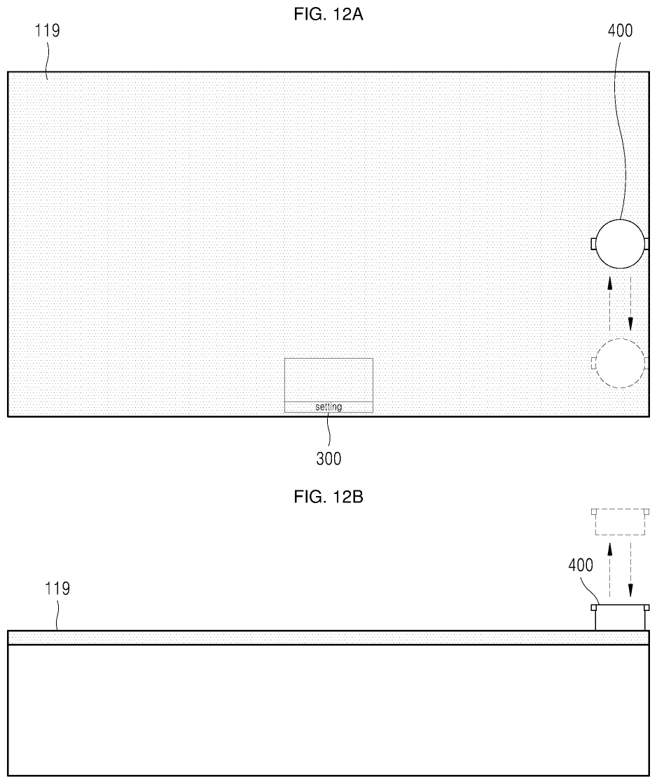

The situations in which the heated item is relocated are illustrated in FIG. 12A. As illustrated in FIG. 12A, the heated item located at the second-second position 1030 may be slid in the vertical direction and then relocated at the second-second position 1030 within the preset time, and as illustrated in FIG. 11B, the heated item located at the second-second position 1030 may be lifted and then relocated at the second-second position 1030 within the preset time.

In this case, when the heated item is relocated at the second-second position 1030, the control unit may control the input interface to display a second image that displays the time of the timer, and when the input interface receives, from the user, a touch input for changing the time of the timer, the control unit may set the time of the timer based on the touch input.

When the user is provided with the timer function, the user may want to increase or decrease the heat power of the second-second position 1030 because the heat power is high or low.

In this case, the user may slide the heated item located at the second-second position 1030 to a third position in the first direction (e.g. the vertical direction). In this case, the control unit may control at least one of the input interface and at least one working coil disposed at the third position, in order to provide a second heat power adjusting function of maintaining the time of the timer and differently adjusting the heat power of the second-second position 1030 from the heat power of the third position.

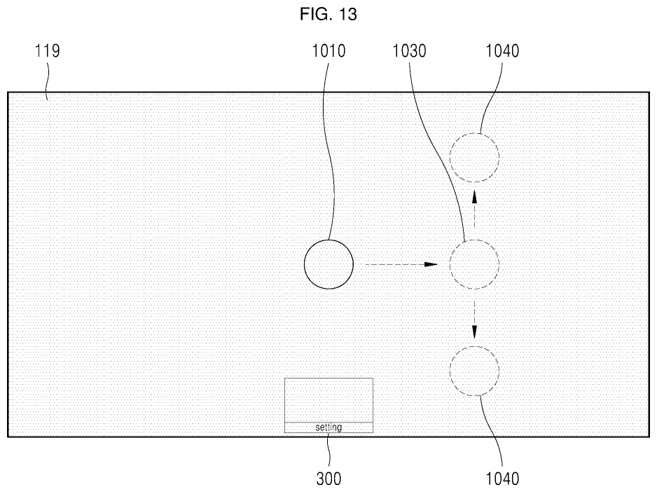

FIG. 13 is a diagram illustrating the concept of an operation of providing the second heat power adjusting function to the heated item located at the second position.

Referring to FIG. 13, when a third position 1040 is located in the upward direction from the second-second position 1030, i.e. the first-first direction, the control unit may set the heat power by at least one working coil, disposed at the third position 1040, to lower heat power than the heat power by at least one working coil disposed at the second-second position 1030, in proportion to the distance between the second-second position 1030 and the third position 1040.

Furthermore, when the third position 1040 is located in the downward direction from the second-second position 1030, i.e. the first-second direction, the control unit may set the heat power by at least one working coil, disposed at the third position 1040, to higher heat power than the heat power by at least one working coil disposed at the second-second position 1030, in proportion to the distance between the second-second position 1030 and the third position 1040.

In this case, when the heated item is located at the third position 1040, the time of the timer is maintained as the same time as the time of the timer located at the second-second position 1030. As the time elapses, the time of the timer decreases.

In short, when the item that is being heated is moved to another position, the induction heating device in accordance with the embodiment of the present disclosure may determine how the heated item is moved, and provide a specific function corresponding to the determination result. In this case, the specific function may be the first heat power adjusting function of maintaining the same heat power, the second heat power adjusting function of increasing/decreasing the heat power, and the additional function such as the child lock function or the timer function.

Therefore, the induction heating device in accordance with the present disclosure may rapidly adjust the heat power, and adjust the heat power of the induction heating device or provide the additional function by using a user's gesture for a cooking vessel. Furthermore, in accordance with the present disclosure, even when an emergency situation occurs during a process of performing cooking by using the induction heating device, a user may rapidly settle the emergency situation without a separate operation, and the additional function different from the main function of the induction heating device that provides heat power may be conveniently provided.

The embodiments of the present disclosure may be implemented as a program command which can be executed through various computer units, and recorded into a computer readable medium. The computer readable medium may include each or combinations of a program command, a data file, a data structure and the like.

In the present disclosure, specific matters and limited embodiments such as specific constituent elements have been described with reference to the drawings, but these descriptions are provided only for assisting comprehensive understanding of the present disclosure, and the present disclosure is not limited to the embodiments, and those skilled in the art to which the present disclosure pertains may change and modify the present disclosure on the basis of these descriptions. Therefore, the spirit of the present disclosure should not be defined as being limited to the embodiments described above, and it should be understood that not only the claims to be described below but also all the equivalents or equivalent modifications of the claims fall within the scope of the spirit of the present disclosure.

What is claimed is:

1. An electric range comprising:
a case;
a plurality of heating units arranged in the case, and disposed at a plurality of regions so as to be spaced apart from each other;
a cover plate coupled to the top of the case;
an input interface disposed on a top surface of the cover plate, and configured to display a specific image; and
a control unit configured to control the heating units and the input interface,
wherein an item to be heated is located at a first position on the top surface of the cover plate, and heated by the heating unit disposed at the first position,
wherein when the heated item is moved from the first position to a second position on the top surface of the cover plate, the control unit determines how the heated item is moved, and controls at least one of the input interface and at least one heating unit to provide a function corresponding to the determination result.

2. The electric range of claim 1, wherein when the heated item is lifted at the first position and moved to the second position, the control unit controls the heating unit to provide a first heat power adjusting function,
wherein the first heat power adjusting function is a function of setting the heat power of the heating unit disposed at the second position to the same heat power as the heat power of the heating unit disposed at the first position.

3. The electric range of claim 1, wherein when the heated item is slid from the first position to the second position, the control unit controls at least one of the heating unit and the input interface to provide a second heat power adjusting function or an additional function,
wherein the second heat power adjusting function is a function of setting the heat power of the heating unit disposed at the second position to heat power different from the heat power of the heating unit disposed at the first position, and
the additional function is a different function from the heat power adjusting function of the heating units to provide heat power.

4. The electric range of claim 3, wherein when the heated item is slid in a first direction of a vertical direction and a horizontal direction and located at the second position, the control unit controls the heating unit to provide the second heat power adjusting function,
wherein when the heated item is slid in a second direction of the vertical and horizontal directions and located at the second position, the control unit controls at least one of the heating unit and the input interface to provide the additional function.

5. The electric range of claim 4, wherein when the heated item is slid in the first direction, the control unit sets the heat power of the heating unit disposed at the second position to lower heat power than the heat power of the heating unit disposed at the first position.

6. The electric range of claim 4, wherein the first direction comprises a first-first direction and a first-second direction, and the first-first direction is opposite to the first-second direction,
wherein when the heated item is slid in the first-first direction and located at the second position, the control unit sets the heat power of the heating unit, disposed at the second position, to lower heat power than the heat power of the heating unit disposed at the first position, in proportion to a distance between the first position and the second position, and
when the heated item is slid in the first-second direction and located at the second position, the control unit sets the heat power of the heating unit, disposed at the second position, to higher heat power than the heat power of the heating unit disposed at the first position, in proportion to the distance between the first position and the second position.

7. The electric range of claim 6, wherein when the second position is an end position in the first-first direction, the control unit sets the heat power of the second position to default minimum heat power, and
when the second position is an end position in the first-second direction, the control unit sets the heat power of the second position to default maximum heat power.

8. The electric range of claim 4, wherein the additional function comprises a first additional function and a second additional function,
wherein when the heated item is slid in the second direction of the vertical and horizontal directions and located at the second position and the second position is spaced by a first distance apart from the first position, the control unit controls at least one of the heating unit and the input interface to provide the first additional function, and
when the heated item is slid in the second direction and located at the second position and the second position is spaced by a second distance apart from the first position, the control unit controls at least one of the heating unit and the input interface to provide the second additional function.

9. The electric range of claim 8, wherein the first additional function is a lock function of setting the input interface to a lock state while the heat power of the second position is set to the same heat power as the heat power of the first position, when the heated item is slid in the second direction, and
the second additional function is a timer function of setting the heat power of the second position to the same heat power as the heat power of the first position, maintaining the set heat power for a specific time, and then turning off the set heat power, when the heated item is slid in the second direction.

10. The electric range of claim 4, wherein the additional function is a timer function,
wherein the control unit sets the time of the timer in proportion to the distance between the first position and the second position.

11. The electric range of claim 10, wherein when the heated item located at the second position is slid to a third position in the first direction,
the control unit maintains the time of the timer, and controls at least one of the heating unit and the input interface to provide a second heat power adjusting function of adjusting the heat power of the second position to heat power different from the heat power of the third position.

12. The electric range of claim 11, wherein the first direction comprises a first-first direction and a first-second direction, and the first-first direction is opposite to the first-second direction,
wherein when the third position is located in the first-first direction from the second position, the control unit sets the heat power of the heating unit, disposed at the third position, to lower heat power than the heat power of the heating unit disposed at the second position, in proportion to the distance between the second position and the third position, and
when the third position is located in the first-second direction from the second position, the control unit sets the heat power of the heating unit, disposed at the third position, to higher heat power than the heat power of the heating unit disposed at the second position, in proportion to the distance between the second position and the third position.

13. The electric range of claim 1, wherein the heating unit is a working coil, and
the control unit determines how the heated item is moved, by measuring how much a resonance current flowing through the working coil is attenuated.

14. The electric range of claim 13, wherein when no resonance current flows through the working coil disposed at a position between the first position and the second position, the control unit determines that the heated item is lifted at the first position and moved to the second position, and
when a resonance current flows through the working coil disposed at a position between the first position and the second position, the control unit determines that the heated item is slid from the first position to the second position.

15. The electric range of claim 1, further comprising a height measurement unit configured to measure the height of the heated item,
wherein when the measured height of the heated item is equal to or more than a critical height, the control unit determines that the heated item is lifted at the first position and moved to the second position, and
when the measured height of the heated item is less than the critical height, the control unit determines that the heated item is slid from the first position to the second position.

16. An electric range comprising:
a case;
a plurality of heating units arranged in the case, and disposed at a plurality of regions so as to be spaced apart from each other;
a cover plate coupled to the top of the case;
an input interface disposed on a top surface of the cover plate, and configured to display a specific image; and
a control unit configured to control the heating units and the input interface,
wherein an item to be heated is located at a first position on the top surface of the cover plate, and heated by the heating unit disposed at the first position,
wherein when the heated item is lifted at the first position and moved to a second position on the top surface of the cover plate, the control unit controls the heating unit to provide a first heat power adjusting function, and
when the heated item is slid from the first position to the second position, the control unit controls at least one of the heating unit and the input interface to provide a second heat power adjusting function or an additional function.
